(19) United States
(12) Patent Application Publication
(10) Pub. No.: US 2010/0231927 A1
(43) Pub. Date: Sep. 16, 2010

(54) METHOD AND DEVICE FOR MEASURING THE POSITION OF THE EDGE OF A MATERIAL WEB

(76) Inventors: Theodor August Nacke, Leopoldshohe (DE); Thomas Klemens Felix Klatte, Bad Salzuflen (DE); Michael Robert Wiebe, Leopoldshohe (DE)

Correspondence Address: KLEIN, O''NEILL & SINGH, LLP, 18200 VON KARMAN AVENUE, SUITE 725, IRVINE, CA, 92612, US

(21) Appl. No.: 12/724,279

(22) Filed: Mar. 15, 2010

(30) Foreign Application Priority Data
Mar. 13, 2009 (DE) 10 2009 012 997.9

(51) Int. Cl. G01B 11/14

(52) U.S. Cl. 356/614

(57) ABSTRACT

A device and method provide for measuring the position of the edge of a material web by illuminating an area of the edge area and detecting shadows cast by the material web. Two or more transmitters arranged in a line transverse to the edge of the material web are used for illumination. A linear sensor also arranged transverse to the edge of the material web is used to sense the locations of the shadows. The position of the edge of the material web is detected from the sensed shadow and the locations of the transmitters and sensors.

### CROSS-REFERENCE TO RELATED APPLICATION

This application claims priority to German patent application DE 10 2009 012 997.9 filed Mar. 13, 2009, the contents of which are expressly incorporated herein by reference as if set forth in full.

### BACKGROUND

This disclosure relates to measuring the position of an edge of an object and more particularly to measuring the position of the edge of a moving material web that is continuously printed by a printing machine.

Measuring the position of the edge of a moving material web has been performed using an illumination device and a sensor with lenses used to map the edge onto the sensor. The illumination device having lenses and the sensor can be positioned at a certain distance from the edge of the material web. The prior measuring techniques have drawbacks including the amount of operating expense required.

### SUMMARY

The preferred embodiments of the present methods, apparatus, systems, and components for measuring the position of the edge of a material web have several features, no single one of which is solely responsible for their desirable attributes. Without limiting the scope of the present embodiments as expressed by the claims that follow, their more prominent features now will be discussed briefly. After considering this discussion, and particularly after reading the section entitled “DETAILED DESCRIPTION.” one will understand how the features of the present embodiments provide advantages.

In one aspect, the invention provides a method for measuring the position of an edge of a material web, the method including illuminating the edge of the material web by at least two transmitters, where the transmitters are substantially arranged in a line transverse to the edge of the material web; detecting shadows cast by the edge of the material web on a sensor, where the sensor includes an array of sensor elements substantially arranged in a line transverse to the edge of material web; and calculating the position of the edge of the material web utilizing the locations of the detected shadows and the locations of the transmitters and the sensor.

In one aspect, the invention provides a device for measuring the position of an edge of a material web, the device comprising at least two transmitters substantially arranged in a line transverse to the edge of the material web; a sensor having pixels substantially arranged in a line transverse to the edge of material web, where the sensor is configured to sense shadows cast by the material web when illuminated by the transmitters; and a computing device coupled to the sensor and configured to calculate the position of the edge of the material web from the sensed shadows.

In one aspect, the invention provides a device for measuring the position of an edge of a material web, the device comprising at least two transmitters substantially arranged in a line transverse to the edge of the material web; and a sensor having pixels substantially arranged in a line transverse to the edge of material web, where the sensor is configured to sense shadows cast by the material web when illuminated by the transmitters.

Broadly, embodiments of the present invention are directed to devices, systems, and methods for locating the position of an object relative to another object, such as an edge of a material web relative to a medium.

### BRIEF DESCRIPTION OF THE DRAWINGS

An exemplary embodiment of the invention is explained in more detail below with reference to the drawings, in which:

FIG. 1 is a schematic diagram of an arrangement for measuring the position of the edge of a moving material web in accordance with aspects of the invention;

FIG. 2 is a graph illustrating operation of a sensor in accordance with aspects of the invention;

FIG. 3 is a schematic diagram of another arrangement for measuring the position of the edge of a moving material web in accordance with aspects of the invention;

FIG. 4 is a cross-sectional diagram of a sensor in accordance with aspects of the invention; and

FIG. 5 is a schematic diagram of another arrangement for measuring the position of the edge of a moving material web in accordance with aspects of the invention.

### DETAILED DESCRIPTION

The detailed description set forth below in connection with the appended drawings is intended as a description of presently preferred embodiments of methods, apparatus, systems, and components for measuring the position of the edge of a moving material web provided in accordance with aspects of the present invention and is not intended to represent the only forms in which the present invention may be constructed or utilized. The description sets forth the features and the steps for constructing and using the methods, apparatus, systems, and components for measuring the position of the edge of a moving material web of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like or similar elements or features.

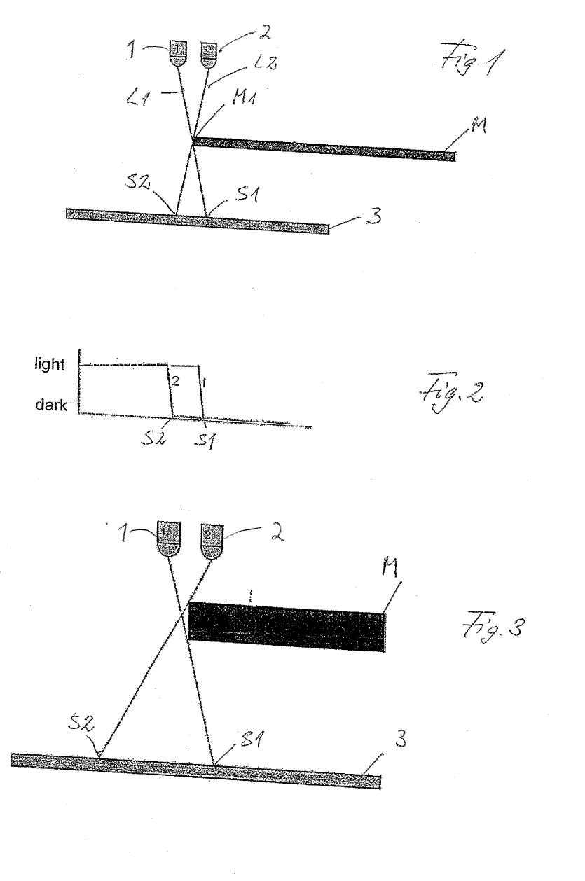

FIG. 1 is a schematic diagram of an arrangement for measuring the position of the edge of a moving material web in accordance with aspects of the invention. A moving material web M, illustrated in cross section, is arranged so that the position of an edge M1 of the material web M may be measured by a measurement device. In certain examples, the material web can be a continuous roll of paper, a continuous roll of fabric, a continuous roll of tissues, napkins, bags, and similar items. The measurement device includes a first transmitter 1 and a second transmitter 2. In one embodiment, each transmitter includes alight emitting diode (LED). The first transmitter 1 and the second transmitter 2 are located generally above the edge M1 of material web M. Above and other directional descriptions are with reference to the figures and are used for convenience of description; however, embodiments of the measurement device may have varying physical orientations. The first transmitter 1 and the second transmitter 2 are separated from each other by a small distance and aligned substantially transverse to the longitudinal direction of the edge M1. The measurement device includes a sensor 3 that is located generally below the edge M1 of material web M. In one embodiment, the sensor 3 is linear or strip-shaped image sensor that includes an array of sensor elements. The sensor 3 is aligned substantially transverse to the longitudinal direction of the edge M1.

The sensor elements sense light from the first transmitter 1 and the second transmitter 2. The amount light detected varies with the position of the edge M1, the position of the sensor elements, the position the transmitters, and which of the transmitters is transmitting. In the arrangement of FIG. 1, light from the first transmitter 1 will reach a first sensor element S1 and other sensor elements to the left of the first sensor element S1. However, light from the first transmitter 1 will be blocked by the material web M and not reach sensor elements to the right of the first sensor element S1. Similarly, light from the second transmitter 2 will reach a second sensor element S2 and other sensor elements to the left of the second sensor element S2 but will be blocked by the material web M and not reach sensor elements to the right of the second sensor element 32. Those sensor elements blocked by the material web M may be termed to be within a “shadow” of the material web. Sensor position S1 is at the edge of the shadow cast when the first transmitter 1 is transmitting, and sensor position S2 is at the edge of the shadow cast when the second transmitter 2 is transmitting.

FIG. 2 is a graph illustrating operation of the sensor 3 of FIG. 1. The abscissa shows the position of sensor elements and the ordinate shows the output of the sensor elements. Sensor elements located to the left on the sensor 3 are not blocked by the material web M and produce an output generally described as “light.” Sensor elements located to the right on the sensor 3 are blocked by the material web M and produce an output generally described as “dark.” In one embodiment, the sensor supplies output voltages in proportion to the amount of light sensed with the “light” sensor elements producing a high voltage level and “dark” sensor elements producing a low voltage level, for example, zero volts. FIG. 1 graphs a first line 1 corresponding to sensor outputs when the first transmitter 1 is transmitting and a second line 1 corresponding to sensor outputs when the second transmitter 2 is transmitting. The sensor outputs when the first transmitter 1 is transmitting transition from a high level to a low level at an abscissa location corresponding to the location of the first sensor element S1. The sensor outputs when the second transmitter 2 is transmitting transition from a high level to a low level at an abscissa location corresponding to the location of the second sensor element S2. The sensor outputs signal locations of shadows cast by the material web.

The device may determine the position of the material edge using the output of the sensor 3. Geometric calculations using the locations of the transmitters 1, 2, the location of the sensor 3, and the positions shadows on the sensor 3 may determine the position of the edge M1. The position may be determined horizontally and vertically. For example, as the edge M1 moves to the left, the shadows move to the left and the first and second sensor positions S1, S2 move to the left. As the edge M1 moves upward, the edges of the shadows become increasingly separated with the first sensor position S1 moving to the left and the second sensor position S2 moving to the right. Thus, a feature of the present invention includes a device, system, and method for finding an edge M1 of a material web M using at least two transmitters 1, 2 at spaced apart locations to transmit signals that are partially blocked by the material web so that one or more shadows are cast against a sensor. In a specific feature of the present device, system, and method, light rays from the first transmitter cross path with light rays from the second transmitter.

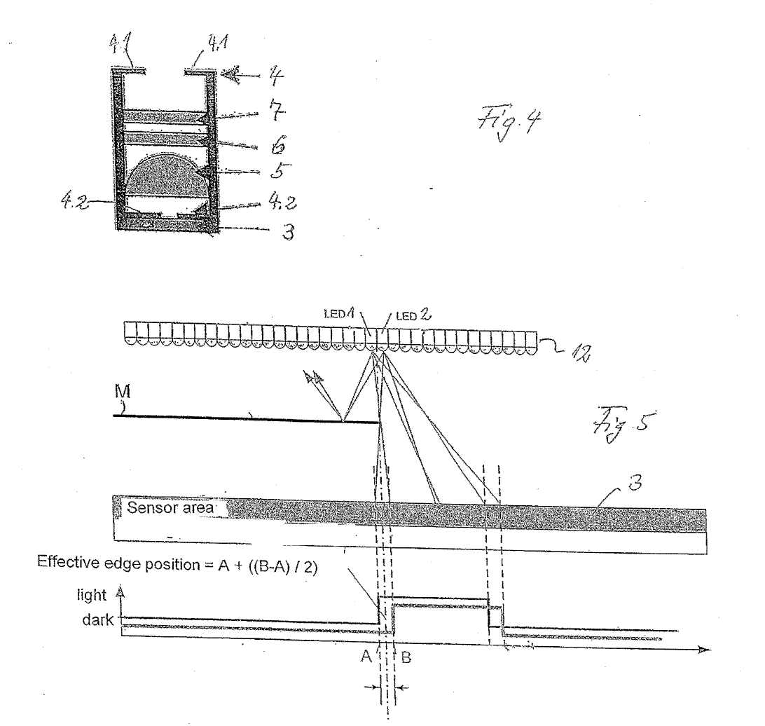

FIG. 3 is a schematic diagram of another arrangement for measuring the position of the edge of a moving material web in accordance with aspects of the invention. Relative to FIG. 1, FIG. 3 illustrates measurement of the position of the edge of a material web M having greater thickness. In the case of a thicker material web M, to avoid distortion of the measurement result due to the material thickness, the first and second transmitters 1, 2 may be positioned such that the incident light of the first transmitter 1 falls in a slanting manner on an edge area of the material web M with the lower edge casting a shadow at a first sensor position S1, while the incident light of the second transmitter 2 falls in a slanting manner on the edge area with the upper edge casting a shadow at a second sensor position 32. As illustrated in FIG. 3, the first transmitter 1 may be positioned to the left of the border of the material web M and the second transmitter 2 to the right of the border. Since the shadows cast at first and second sensor positions S1, S2 are located at the sensor 3 by the upper and lower edges at the border of the material web M, the thickness of the material web M, when known, may be computationally compensated for in calculating the position of the edge of the material web.

Using a measurement device with two transmitters, as illustrated in FIG. 1 or 2, two characteristics of an edge of a material web may be measured. For example, when the thickness of the material web is known, the vertical position and horizontal position may be determined. In another example, when the vertical position of the material web is known, the thickness and horizontal position may be determined.

A computing device, for example, a microcontroller, a personal computer, or an industrial controller, may be associated with the measuring devices of FIG. 1 or 2. The computing device processes signals from the sensor 3 for measuring the position of the edge of the material web M. The computing device may additionally control activating the transmitters 1, 2.

In one embodiment, the sensor 3 is a CMOS sensor with a length of 214 mm and 2584 sensor elements or pixels with 12 pixels/mm (300 dpi). In other embodiments, the sensor 3 is a charge-coupled device (CCD) sensor. The 2584 pixels may be accessed at a rate of 2.5 MHz with 1.25 ms to scan the full sensor. The sensor may include a sensor board as a contact image sensor (CIS) module. Such a board can be disassembled very easily. CIS modules commonly include small lenses mounted in front of each pixel of the sensor. The lenses cause a short depth of field, for example, 2 mm. In the present measurement device, the sensor generally is configured without individual lenses for each pixel. This allows the sensor to generate reliable signals even when the sensor is more distant from the material web.

In another embodiment, the sensor 3 is elongated, for example, to 800 mm. A method of measuring the position of the edge of a moving material web includes, preferably, at least two scans of the sensor 3. For the above-mentioned CMOS sensor, this results in a cycle time of 2.5 ms.

FIG. 4 is a cross-sectional view of a sensor structure in accordance with aspects of the invention. The sensor structure may be associated with the sensor 3 of the measurement device of FIG. 1 or 2. Sensor structure includes a housing 4 having an approximately U-shaped cross section. The housing 4 has shoulders 4.1 that are bent inwards at the open end of the U-shaped cross section to define an opening for incident light and to form a light trap. At the bottom of the housing 4, a sensor 3 is located. The housing 4 includes covers 4.2 that covers border areas of the sensor 3 with the covers 4.2 separated from each other to form a light trap. The sensor structure includes a semicircular rod 5 positioned between the light trap near the top of the housing 4 and the light trap near the sensor 3. The semicircular rod 5 provides a lens for focusing incident light on the separation between the covers 4.2. In some embodiments, the sensor structure additionally includes a film 6 positioned between the semicircular rod 5 the opening for incident light. The film 6 suppresses incident light from the left or right. An ambient light filter 7 located between the sensor 3 and the opening for incident light is included in some embodiments of the sensor structure. The shoulders 4.1, covers 4.2, and semicircular rod 5 direct incident light to the sensor 3 and aid suppression of extraneous light.

FIG. 5 is schematic diagram of another arrangement for measuring the position of the edge of a moving material web in accordance with aspects of the invention. The measurement device of FIG. 5 includes a transmitter array 12 arranged substantially transverse to a border of a material web M. The transmitter array 12 may be a linear array of LEDs. The measurement device includes a sensor 3 that is the same or similar to the sensor of FIG. 1. In one embodiment, the sensor 3 is a CIS module with pixels at 600 dpi. FIG. 5 illustrates light emanating from the two activated transmitters, a first transmitter 1 and a second transmitter 2, and the resulting signal (light/dark) at the sensor 3. Which of the transmitters in the transmitter array 12 are activated may be adjusted to improve sensing of the position of the material web M. For example, use of transmitters nearer the edge of the material web may provide more accurate positioning. A method of measuring the edge position may include determining which transmitters to use by, for example, a binary search. In one embodiment, transmitting elements are selected such that edges of the associated shadows from the material lie on adjacent pixels of the sensor 3.

In some embodiments, more than two transmitters may be used to measure the position of the edge. The use of additional transmitters may reduce impairment of measurements due to sensor noise, alignment errors, or the like. In further embodiments, the use of additional transmitters may be used make combined measurements of vertical position, horizontal position, and thickness of the material web.

Although the present invention has been described with reference to specific embodiments, these embodiments are illustrative only and not limiting. Many other applications and embodiments will be apparent in light of this disclosure and the following claims.

What is claimed is:

1. A method for measuring a position of an edge of a material web, the method comprising:
illuminating the edge of the material web by at least two transmitters, where the transmitters are substantially arranged in a line transverse to the edge of the material web;
detecting shadows cast by the edge of the material web on a sensor, where the sensor includes an array of sensor elements substantially arranged in a line transverse to the edge of material web; and
calculating the position of the edge of the material web.

2. The method of claim 1, wherein calculating the position of the edge of the material web comprises utilizing, at least in part, the locations of the detected shadows and the locations of the transmitters and the sensor, and calculating the position of the edge of the material web in the direction between the transmitters and the sensor, the position based at least in part on the difference in the locations of the detected shadows.

3. The method of claim 1, wherein illuminating the edge of the material web by the at least two transmitters and detecting shadows cast by the edge of the material web on the sensor are performed consecutively for each of the at least two transmitters.

4. The method of claim 1, further comprising selected transmitters from an array of transmitters for use in illuminating the edge of the material web by the at least two transmitters.

5. A device for measuring the position of an edge of a material web, the device comprising:
at least two transmitters substantially arranged in a line transverse to the edge of the material web;
a sensor having pixels substantially arranged in a line transverse to the edge of material web, where the sensor is configured to sense shadows cast by the material web when illuminated by the transmitters; and
a computing device coupled to the sensor and configured to calculate the position of the edge of the material web from the sensed shadows.

6. The device of claim 5, wherein the at least two transmitters are in a row of transmitters substantially arranged transverse to the edge of the material web, and wherein the computing device is further coupled to the transmitters and is further configured to control which of transmitters in the row of transmitters are activated to calculate the position of the edge of the material web.

7. The device of claim 5, wherein each of the at least two transmitters comprises a light-emitting diode.

8. The device of claim 5, wherein the sensor is selected from the group consisting of a CCD sensor, a CMOS sensor, and a contact image sensor.

9. The device of claim 5, further comprising a semicircular rod arranged as a lens over the sensor and configured to focus light from the at least two transmitters on the sensor.

10. The device of claim 5, further comprising a housing having a U-shaped cross section, wherein the sensor is located in the housing.

11. The device of claim 10, wherein the housing forms at least one light trap by narrowing an opening area over the sensor.

12. The device of claim 11, further comprising a semicircular rod arranged as a lens over the sensor and configured to focus light from the at least two transmitters on the sensor.

13. The device of claim 12, where further comprising a light filter arranged in the housing and configured to suppress ambient light from the sensor.

14. A device for measuring the position of an edge of a material web, the device comprising:
at least two transmitters substantially arranged in a line transverse to the edge of the material web; and
a sensor having pixels substantially arranged in a line transverse to the edge of material web, where the sensor is configured to sense shadows cast by the material web when illuminated by the transmitters.

15. The device of claim 14, wherein each of the at least two transmitters comprises a light-emitting diode.

16. The device of claim 14, wherein the sensor is selected from the group consisting of a CCD sensor, a CMOS sensor, and a contact image sensor.

17. The device of claim 14, further comprising a housing having a U-shaped cross section, wherein the sensor is located in the housing.

18. The device of claim 17, wherein the housing forms at least one light trap by narrowing an opening area over the sensor.

19. The device of claim 18, further comprising a semicircular rod arranged as a lens over the sensor and configured to focus light from the at least two transmitters on the sensor.

20. The device of claim 19, where further comprising a light filter arranged in the housing an configured to suppress ambient light from the sensor.
